(19) United States
(12) Patent Application Publication
(10) Pub. No.: US 2024/0233051 A1
(43) Pub. Date: Jul. 11, 2024

(54) Device, Method and Program for Fan to Perform Gifting

(71) Applicant: ENGATE, INC., Chuo-ku (JP)

(72) Inventors: Koichiro KIDO, Chuo-ku (JP); Kurando MINAMI, Chuo-ku (JP); Kenshiro TAMURA, Chuo-ku (JP)

(21) Appl. No.: 18/288,883

(22) PCT Filed: Apr. 29, 2022
(86) PCT No.: PCT/JP2022/019470

§ 371 Date: Jan. 5, 2024

(30) Foreign Application Priority Data
Apr. 30, 2021 (JP) 2021-078137

(51) Int. Cl. G06Q 50/10; G06Q 30/0601

(52) U.S. Cl. CPC G06Q 50/10; G06Q 30/0601

(57) ABSTRACT

A method for a fan to perform gifting. First, a point issuing request is received from a fan terminal 110 (S201). An apparatus 100 issues points corresponding to an amount of consideration in response to the issuing request, and stores the points in association with a fan identifier (S202). Next, the apparatus 100 receives from the fan terminal 110 a purchase request for a gift specifying a team or a player in the team (S203). The apparatus 100 determines whether points required for the selected gift are at most equal to points granted to the fan (S204). The apparatus 100 then receives a gift information acquisition request (S205), and a display terminal 130 acquires gift information (S206). On the basis of the gift information, the display terminal 130 displays one or a plurality of gifts superimposed on a background image (S207), and mirrors the output to the display screen on a large-size display 120 (S208).

### TECHNICAL FIELD

This invention relates to an apparatus and a method for a fan to perform gifting and a program therefor.

### BACKGROUND ART

In addition to admission fees for games played in stadiums, sports teams' main sources of revenue are advertising revenues from sponsors, broadcasting rights revenues for broadcasting or distributing games, and revenues from the sale of goods related to the team or its players, etc. The revenues thus obtained are used for player compensation, player development, etc.

Among the above revenue sources, the sale of goods, unlike admission fees, can occur at any time, regardless of whether there is a game or not, and is a promising means for strengthening the operational base of sports teams. The applicant provides sports fans with a “gifting” mechanism in which digital contents, called gifts, are sold that can be given to teams or their players. On the website “Engate (registered trademark)”, team-specific web pages are available, where gifts can be given by designating the team or its player as the recipient. When gifting takes place, the page displays who has given which gift to whom. For example, fans can express their feelings about the game by gifting during the game, and they can express their expectation, support and the like for the team or its players by gifting before and after the game.

### SUMMARY OF INVENTION

### Technical Problem

Fans have various motivations for gifting, and if there is a technique to express their enthusiasm for teams or their players more strongly during a game, teams can provide fans with a richer game-watching experience by using a gifting service that has the functionality to enable that technique.

The present invention was made in view of the problem, and its objective is to provide a new technique for a fan to perform gifting during a game in an apparatus or a method for a fan to perform gifting or a program therefor.

As used herein, “during a game” refers to the period of time when fans can enter the stadium to watch a game, and includes a time other than a time during which the game is played.

### Solution to Problem

To achieve the objective, the first aspect of the present invention is a method for a fan to perform gifting, comprising: an apparatus issuing points for purchasing a gift to the fan; the apparatus receiving, from a first terminal used by the fan, a request to purchase a gift using the points, the request specifying a team or a player of the team; the apparatus transmitting, within a predetermined time period during a game, to a second terminal connected to a large-size display installed in a stadium, gift information regarding one or more gifts purchased in connection with the team within the predetermined time period; the second terminal displaying, on its display screen, based on the gift information, one or more gift images of the one or more gifts included in the gift information superimposed over a background image; and the second terminal mirroring the output to the display screen to the large-size display.

The second aspect of the present invention is the method of the first aspect, wherein the first terminal is a smartphone.

The third aspect of the present invention is the method of the first aspect, wherein the predetermined time includes a time during the game other than a time during the game is played.

The fourth aspect of the present invention is the method of any one of the first to third aspects, wherein the background image changes within the predetermined time.

The fifth aspect of the present invention is the method of the first aspect, wherein the displaying is performed only for ones among the one or more gifts for which location information regarding purchase location corresponds to a location in the stadium.

The sixth aspect of the present invention is the method according to any one the first to the fifth aspects, wherein the displaying is performed by full screen display on a web browser.

The seventh aspect of the present invention is the method according to any one of the first to the sixth aspects, wherein the gift image is displayed using an identical form of expression as an expression included in the background image.

The eighth aspect of the present invention is the method according to any one of the first to the seventh aspects, wherein the displaying includes displaying an identifier of a fan who purchased each of the one or more gifts or a name corresponding to the identifier.

The ninth aspect of the present invention is a program for causing a computer to perform a method for a fan to perform gifting, the method comprising: an apparatus issuing points for purchasing a gift to the fan; the apparatus receiving, from a first terminal used by the fan, a request to purchase a gift using the points, the request specifying a team or a player of the team; the apparatus transmitting, within a predetermined time period during a game, to a second terminal connected to a large-size display installed in a stadium, gift information regarding one or more gifts purchased in connection with the team within the predetermined time period; the second terminal displaying, on its display screen, based on the gift information, one or more gift images of the one or more gifts included in the gift information superimposed over a background image; and the second terminal mirroring the output to the display screen to the large-size display.

The tenth aspect of the invention is an apparatus for a fan to perform gifting, configured to: issue points for purchasing a gift to the fan; receive, from a first terminal used by the fan, a request to purchase a gift using the points, the request specifying a team or a player of the team; transmit, within a predetermined time period during a game, to a second terminal connected to a large-size display installed in a stadium, gift information regarding one or more gifts purchased in connection with the team within the predetermined time period; display, on its display screen, based on the gift information, one or more gift images of the one or more gifts included in the gift information superimposed over a background image; and mirror the output to the display screen to the large-size display.

According to an aspect of the present invention, gifting performed by fans within an appropriate predetermined time during a game, depending on the type of the sport, is displayed together with a background image on a large-size display installed in a stadium where the game is being played. This provides fans with a richer spectator experience that unites them with the stadium, unlike the experience confined to their own terminals such as smartphones.

### BRIEF DESCRIPTION OF DRAWINGS

FIG. 1 shows an apparatus according to an embodiment of the present invention.

FIG. 2 shows the flow of a method for performing gifting according to an embodiment of the present invention.

FIG. 3A shows an example of gift information according to an embodiment of the present invention.

FIG. 3B shows the continuation of the example of gift information according to an embodiment of the present invention.

FIG. 4A is for explaining gift display according to an embodiment of the present invention.

FIG. 4B is for explaining gift display according to an embodiment of the present invention.

### DESCRIPTION OF EMBODIMENTS

The following is a detailed description of the embodiment of the present invention with reference to the drawings.

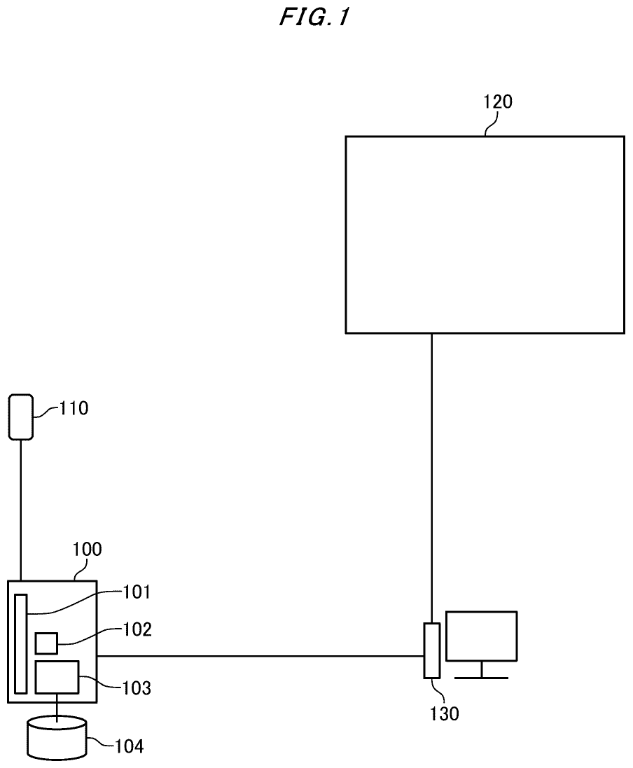

FIG. 1 shows an apparatus according to an embodiment of the present invention. The apparatus 100 communicates with a fan terminal 110 used by a fan via an IP network such as the Internet to provide a gifting service. The apparatus 100 is also connected to a large-size display 120 such as Aurora Vision (registered trademark) installed in a stadium and communicates via an IP network with a display terminal 130 for displaying images on the large-size display 120. Hereafter, the fan terminal 110 may be referred to as the first terminal and the display terminal 130 as the second terminal. The fan terminal 110 can be a portable terminal such as a smartphone or tablet. The display terminal 130 can be a PC or the like. The term “large-size display” herein refers to a display of 120 inches or larger, and depending on the stadium or the sport, 130 inches or larger, 200 inches or larger, 300 inches or larger, or 500 inches or larger are preferred. More specifically, displays of 800 inches, 1011 inches, 1170 inches, etc. are examples.

The apparatus 100 comprises a communication unit 101, such as a communication interface, a processing unit 102, such as a processor or CPU, and a storage unit 103, including a storage apparatus or storage medium such as a memory, hard disk, etc., and can be configures by executing a program for performing each process. The apparatus 100 may include one or more apparatuses, computers or servers. The program may include one or more programs, and may be recorded on a computer-readable storage medium to form a non-transitory program product. The program can be stored in a storage unit 103 or in a storage apparatus or storage medium such as a database 104 accessible via an IP network from the apparatus 100, and can be executed in the processing unit 102. Data described below as being stored in the storage unit 103 may be stored in the database 104, and vice versa. The display terminal 130 is not shown in the figure, but can be configured in the same manner as the apparatus 100.

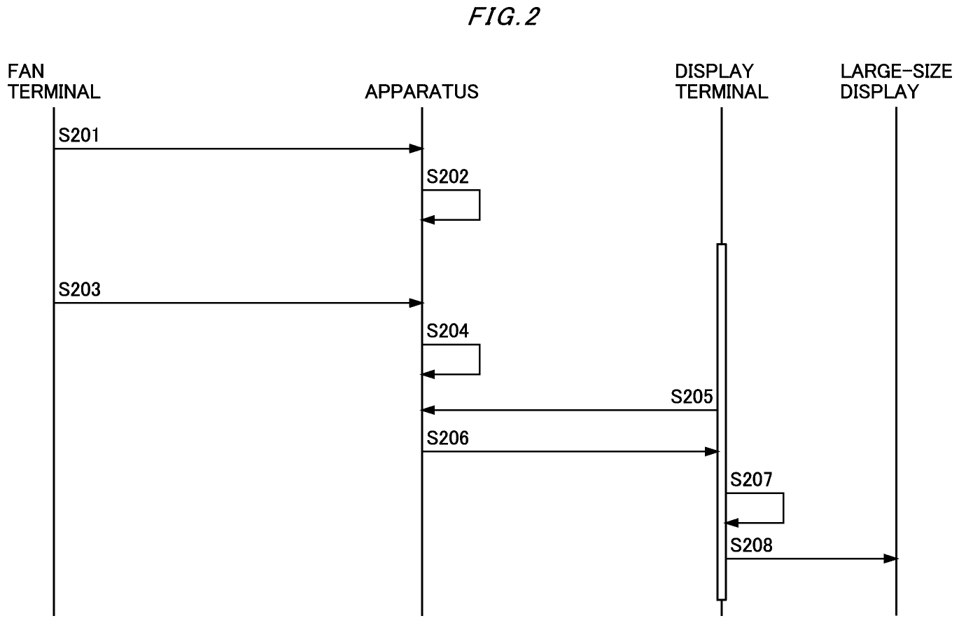

FIG. 2 shows the flow of the method for performing gifting according to an embodiment of the present invention. First, a request for issuing points is received from the fan terminal 110 (S201). In response to the issuance request, the apparatus 100 issues points to the fan using the fan terminal 110 in proportion to the quantity of consideration included in the issuance request, and stores the points in the storage unit 103 in association with a fan identifier of the fan in the gifting service provided by the apparatus 100 (S202). Here, points are described as a means of payment having a property value issued by paying a consideration, but they may also be issued without requiring payment of a consideration.

Next, the apparatus 100 receives a purchase request for a gift from the fan terminal 110, specifying the team or its players (S203). The purchase request can be made from the gifting screen displayed on the display screen of the fan terminal 110 in a web browser by sending the gifting screen display information for displaying the screen for gifting from the apparatus 100 to the fan terminal 110, or by running an application installed on the fan terminal 110 and making a purchase request from the gifting screen displayed on the application. In either case, the gifting screen may include a field for selecting the team or player to give a gift to and a field for selecting the gift to be purchased, and may further include a comment field for entering comments on the gifting. The “gifting screen” can be a web page, a modal window, a pop-up window, or any other format when displayed on a web browser, or a screen of an application when displayed on an application. In either case, any screen that includes an area with an input field for gifting is a gifting screen.

Upon receipt of the gift purchase request, the apparatus 100 determines whether the points required for the gift selected for purchase are less than or equal to the points granted to the fan using the fan terminal 110 (S204). If there are sufficient points granted to the fan in question, as a purchase process, the gift identifier of the gift is associated with the fan identifier of the fan in question and stored in the storage unit 103, and the balance of the points stored in association with the fan identifier of the fan in question is updated. The balance update can be performed, as an example, by subtracting the points required for the purchase of the gift from the points stored in association with the fan identifier of the fan in question.

The apparatus 100 then receives a gift information acquisition request from the display terminal 130 (S205). The gift information acquisition request can be made by an HTTP GET request to the apparatus 100, and in more detail, it can be an HTTP GET request to the following URL as an example.

https://api.xxxx.jp/v1/communities/{community id}/timeline

Here, “api.xxxx.jp” is the domain name of the apparatus 100, and the API is called by specifying “community id” as a parameter. Here, specifying “timeline” means that gift information is acquired. The “community id” can, for example, represent the identifier of a team's fan community. When gifts are sent to the team or its players, the gifts are associated with the community id and stored in the storage unit 103, thereby information regarding associated one or more gifts can be acquired by the request (S206). The community id can also be called a team id in the case of a team or a player id in the case of a player. When gifting can be performed for an event such as a game, the given gifts can be stored in the storage unit 103 in association with the event id and information on one or more gifts associated with the event can be acquired by an HTTP GET request specifying the event id. Although the description here assumes that a gift information acquisition request is sent from the display terminal 130 and gift information is sent from the apparatus 100 in response, gift information can also be sent from the apparatus 100 to the display terminal 130 as a push notification.

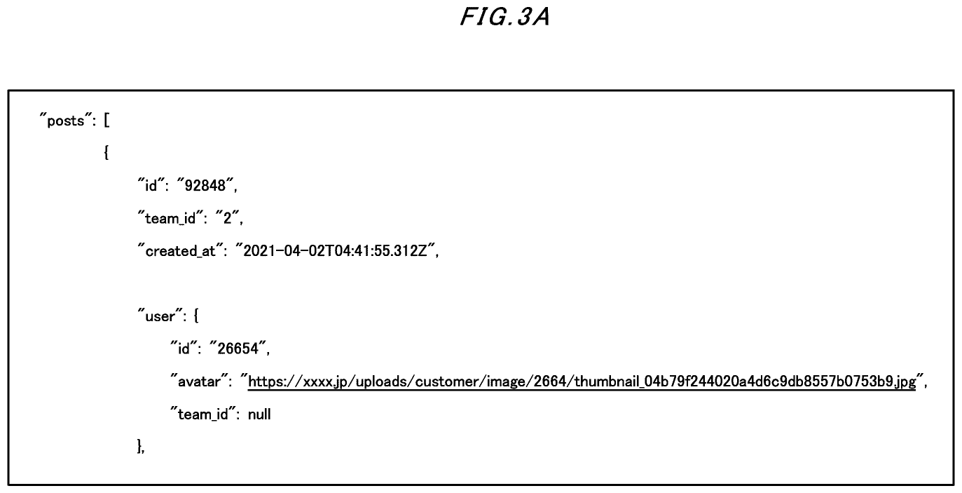

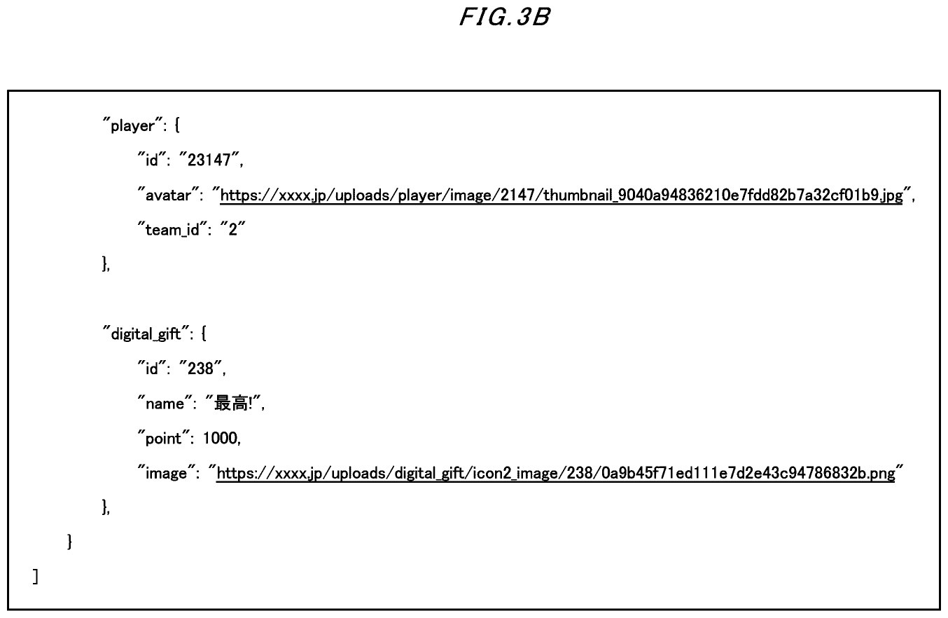

FIGS. 3A and 3B shows an example of gift information. This is the gift information acquired as a result of a gift information acquisition request specifying 2 as the “team id,” and in this example, only one gifting with an “id” of 92848 is included. The identifier “id” of the gifting fan, i.e., the user of the gifting service, is 26654, and the URL of the image that can be used to display who gave which gift to whom is described as “avatar”. The identifier “id” of the player selected as the gifting target is 23147, and the URL of the image that can be used to display who gave which gift to whom is described as “avatar.” It is also described that the player in question belongs to a team with “team id” of 2. Next, the identifier of the gift purchased is 238, and the name of the gift, “name,” and the points required to purchase the gift are described, and the URL of the image that can be used to display the gift is described as “image.”

In FIG. 2, for simplicity, it is illustrated that the gift information acquisition request (S205) is made after the gift purchase process (S204), but at the display terminal 130, gift information acquisition requests can be sent to the apparatus 100 continuously or intermittently over a predetermined time period during the game, and gift information can be acquired for each request. In FIG. 2, the vertical rectangular area shown for the display terminal 130 represents the predetermined time. Alternatively, the apparatus 100 can send gift information to the display terminal 130 as push notifications continuously or intermittently over a predetermined period of time during the game.

As an example, the predetermined time can be started by executing a stored program for transmitting gift information acquisition requests as described above according to predetermined rules. If a period of time for sending gift information acquisition requests is specified in the program, the predetermined time will end when the period of time elapses. The predetermined time can also be terminated by stopping the program. Alternatively, a program for sending gift information acquisition requests at predetermined time intervals may be executed, and the apparatus 100 may notify the start of the predetermined time period, and upon receipt by the display terminal 130, the display terminal 130 may start sending gift information acquisition requests. Similarly, upon receipt of a notification of the end of the predetermined time period from the apparatus 100, the transmission of a gift information acquisition request may be stopped.

Upon receiving the gift information, the display terminal 130 displays the image stored in the storage unit of the display terminal 130 on its display screen and, based on the gift information, superimposes one or more gifts that were not included in the previously received gift information on top of the image (S207). The display terminal 130 then mirrors the output to its display screen to the large-size display 120 (S208). Details regarding the display of the gifts are described below.

In the display terminal 130, the display program for displaying one or more gifts superimposed on the background image may be the same program as the acquisition program for acquiring gift information, or it may be a separate program. Although the above explanation gives an example of sending gift information acquisition requests over a predetermined time period, the gift information may be acquired beyond the predetermined time period and the display program may be configured so that the gift is displayed over the predetermined time period. It may also be that the acquisition of the gift information and the display of the gift are performed beyond a predetermined time period, and the display program is configured so that mirroring is performed over the predetermined time period. Also, in the above explanation, the differences in the gift information are identified in the display program at the display terminal 130, but the gift information itself, which is sent from the apparatus 100 to the display terminal 130, may be only the differences.

Thus, the system comprising the apparatus 100 and the display terminal 130 according to an embodiment of the present invention can provide fans with a richer spectator experience that unites them with the stadium where the game is played, unlike the experience confined to their own terminals such as smartphones, by displaying, together with a background image, on a large-size display installed in the stadium the gifting that fans have done within an appropriate predetermined time during the game depending on the type of a sport.

By making the background image an image which changes within a predetermined time, fans in the stadium are more likely to pay attention to the large-size display, thereby increasing the sense of unity with the stadium felt by gifting fans. By additionally or alternatively making the predetermined time include a time during a game other than a time during which the game is played, fans who are concentrating on watching the game during play are more likely to pay attention to the large-size display, thereby increasing the sense of unity with the stadium felt by the gifting fans. The effect can be further enhanced by making the predetermined time include only the time during the game other than during the game is played. In some cases, players who are concentrating on the game during play can also be expected to pay attention to the large-size display.

The display of the gift image 411 on the large-size display 120 not only provides an opportunity for fans to express their enthusiasm in a new way, it also provides an opportunity for other fans in the stadium to recognize the means of gifting, leading to a further increase in the sense of unity through an increase in the total amount of gifting.

In addition, if the background image on the large-size display 120 to which fans' attention is directed as described above includes a logo or other visual element representing the sponsor of the game, this will provide the sponsor with an opportunity for fans to recognize the sponsor, thereby promoting the acquisition of sponsorship.

If the gift image overlay is performed outside of the playing time, since the broadcast or distribution of the game often does not include images outside of the playing time, especially images of the large-size display 120, the fans who perform gifting knowing that the results of gifting will be displayed on the large-size screen 120 are assumed to be substantially those in the stadium. When displaying one or more gifts included in the gift information as described above, gifting by fans who are not in the stadium is also covered. In the gift purchase process, by obtaining the location information of the fan terminal 110 used by the purchasing fan and including this in the gift information, the display terminal 130 may display only the gift image 411 of the gift that meets the predetermined condition. The predetermined condition may be that the location information regarding the purchase location corresponds to a location within the stadium where the game is being played. Alternatively, the location information may be specified in the gift information acquisition request to acquire the gift information. When the apparatus 100 makes push notifications on the gift information, the gift information may include only the gift images 411 of the gifts for which the location information meet the predetermined condition described above.

The points required to purchase the gift image 411 to be displayed on the large-size display 120 may be a predetermined value or more. In this case, as with the location information, whether or not the points for each gifting are above the predetermined value may be determined at the display terminal 130, or the gift information may be acquired by specifying the points in the gift information acquisition request. Alternatively, whether or not the points for each gifting are above the predetermined value may be determined at the apparatus 100.

In addition, when a comment is entered in the comment field on the gifting screen, although the gift information can include the comment, considering that the gifting done within a predetermined time period is displayed on the large-size display 120 in real time, there is a risk that inappropriate comments may be made in an environment that can be viewed from the entire stadium. Since it is practically difficult to check for such inappropriate comments, it is preferable that the comments not be displayed on the large-size display 120.

### Details for Gift Display

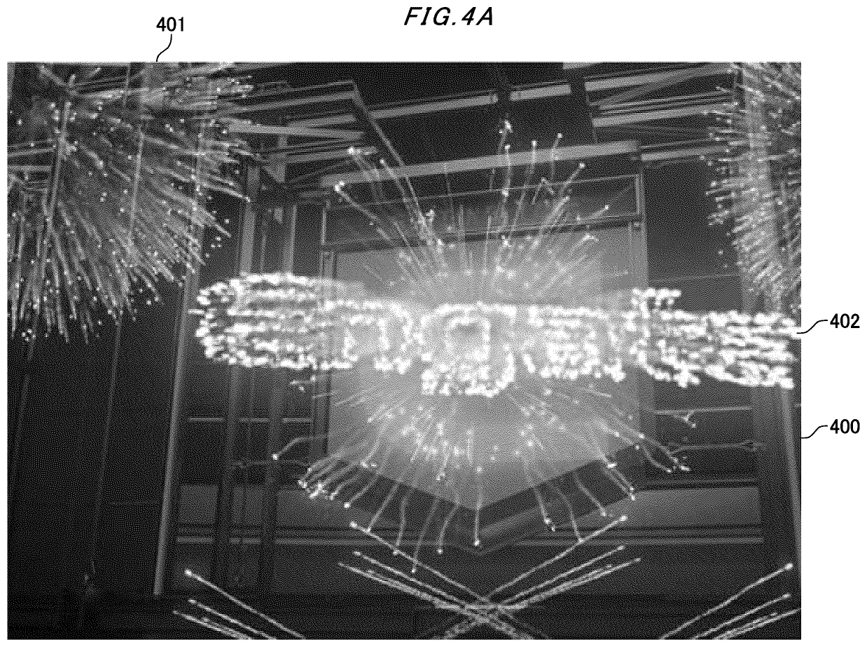

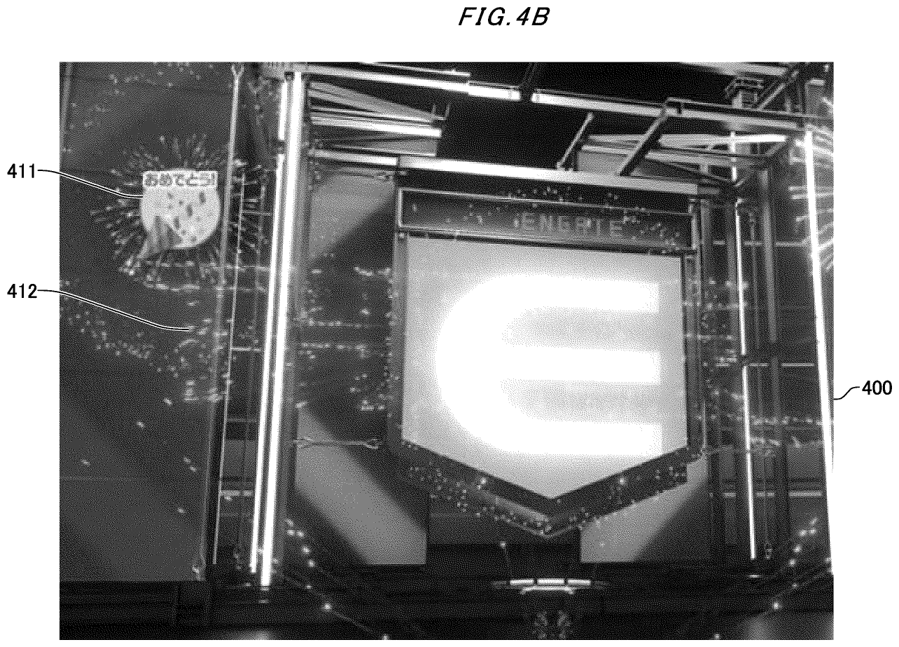

FIG. 4A and FIG. 4B show examples of gift displays. FIG. 4A shows the display terminal 130 displaying an image 400 stored in its storage unit on the display screen. The image 400 changes within a predetermined time period, and in this example, the image 400 depicts fireworks 401 going up. In addition, characters 402 are depicted in an expression that imitates fireworks. In FIG. 4B, the image 400 switches to the next scene as time progresses, and the gift included in the gift information obtained by the display terminal 130 is displayed as the image 411 superimposed on the background image 400. The gift image 411 may be received as part of the gift display, or if the URL of the image is included in the gift information, as in the example shown in FIG. 3B, it may be acquired by accessing the URL. The identifier of the fan who purchased the gift or the name 412 associated with it, “THREE_3,” is also displayed in FIG. 4B. The name of the fan may be received as part of the gift information, or if the identifier of the fan is included in the gift information as in the example shown in FIG. 3B, the name stored for the identifier may be obtained from the apparatus 100 based on the identifier. A fan image associated with the fan identifier may be further displayed. In addition, an identifier of a player selected as a gifting target or a player name associated therewith, a player image associated with the identifier, and the like may be displayed. The fan image and player image may be obtained in the same manner as the gift image 411, and by displaying two or more of the gift image 411, the fan image and the player image in close proximity, it is possible to intuitively convey who gave which gift to whom.

The gift image 411 may be displayed by moving it up and down or left and right, or by fading in or out. The gift image 411 may also be displayed using the same format of expression as that contained in the background image 400, as in FIG. 4 where an expression that imitates fireworks is employed.

The gift images 411 may, in one example, be displayed in the time order in which the gift purchase process is completed. Since they are to remain displayed for about one second or several seconds, when purchased simultaneously with a friend, if a gift information acquisition request is sent to the apparatus 100 at an interval of less than one second, more preferably less than 0.1 second, The periods during which the gift images 411 of the respective purchased gifts are displayed overlap at least in part, enhancing the sense of unity of the spectator experience with the friend. The purchase processing time is indicated by “created_at” in FIG. 3A and can be obtained as part of the gift information.

In the above embodiments, it is to be noted that if the term “only” is not written, such as in “based only on x”, “in response to x only”, or “in the case of x only”, in the present Specification, it is assumed that additional information may also be taken into account. Also, as an example, it is to be noted that a description “b is performed in the case of a” does not necessarily mean “b is always performed in the case of a” or “a is performed immediately after a” except where expressly stated. Also, a description “each a which is part of A” does not necessarily mean that A comprises a plurality of elements and it includes a case where A is composed of a single element.

In addition, as a caveat, even if there are aspects of a method, a program, a terminal, an apparatus, a server or a system (hereinafter referred to as “method, etc.”) that perform operations different from those described herein, each aspect of the invention is intended to perform the same operation as one of the operations described herein, and the existence of an operation different from those described herein does not mean that the method, etc. is outside the scope of each aspect of the invention.

### REFERENCE SIGNS LIST

100 Apparatus
101 Communication unit
102 Processing unit
103 Storage unit
104 Database
110 Fan terminal (equivalent to “first terminal”)
120 Large-size display
130 Display terminal (equivalent to a “second terminal”)
400 Background image
401 Fireworks
402 Character
411 Gift image
412 Name

1. A method for a fan to perform gifting, comprising:
an apparatus issuing points for purchasing a gift to the fan;
the apparatus receiving, from a first terminal used by the fan, a request to purchase a gift using the points, the request specifying a team or a player of the team;
the apparatus transmitting, within a predetermined time period during a game, to a second terminal connected to a large-size display installed in a stadium, gift information regarding one or more gifts purchased in connection with the team within the predetermined time period;
the second terminal displaying, on its display screen, based on the gift information, one or more gift images of the one or more gifts included in the gift information superimposed over a background image; and
the second terminal mirroring the output to the display screen to the large-size display.

2. The method according to claim 1, wherein the first terminal is a smartphone.

3. The method according to claim 1, wherein the predetermined time includes a time during the game other than a time during which the game is played.

4. The method according to claim 1, wherein the background image changes within the predetermined time.

5. The method according to claim 1, wherein the displaying is performed only for gifts among the one or more gifts for which location information regarding purchase location corresponds to a location in the stadium.

6. The method according to claim 1, wherein the displaying is performed by full screen display on a web browser.

7. The method according to claim 1, wherein the gift image is displayed using an identical form of expression as an expression included in the background image.

8. The method according to claim 1, wherein the displaying includes displaying an identifier of a fan who purchased each of the one or more gifts or a name corresponding to the identifier.

9. A program for causing a computer to perform a method for a fan to perform gifting, the method comprising:
an apparatus issuing points for purchasing a gift to the fan;
the apparatus receiving, from a first terminal used by the fan, a request to purchase a gift using the points, the request specifying a team or a player of the team;
the apparatus transmitting, within a predetermined time period during a game, to a second terminal connected to a large-size display installed in a stadium, gift information regarding one or more gifts purchased in connection with the team within the predetermined time period;
the second terminal displaying, on its display screen, based on the gift information, one or more gift images of the one or more gifts included in the gift information superimposed over a background image; and
the second terminal mirroring the output to the display screen to the large-size display.

10. An apparatus for a fan to perform gifting, configured to:
issue points for purchasing a gift to the fan;
receive, from a first terminal used by the fan, a request to purchase a gift using the points, the request specifying a team or a player of the team;
transmit, within a predetermined time period during a game, to a second terminal connected to a large-size display installed in a stadium, gift information regarding one or more gifts purchased in connection with the team within the predetermined time period;
display, on its display screen, based on the gift information, one or more gift images of the one or more gifts included in the gift information superimposed over a background image; and
mirror the output to the display screen to the large-size display.
